(19) United States
(12) Patent Application Publication
(10) Pub. No.: US 2009/0045776 A1
(43) Pub. Date: Feb. 19, 2009

(54) Power System

(76) Inventor: Solomon Chang, Taichung City (TW)

Correspondence Address: Alan D. Kamrath;Kamrath & Associates, P.A., Suite 245, 4825 Olson Memorial Highway, Golden Valley, MN, 55422, US

(21) Appl. No.: 11/839,623

(22) Filed: Aug. 16, 2007

(51) Int. Cl. H02J 7/00

(52) U.S. Cl. 320/128; 173/46

(57) ABSTRACT

A power system comprises: a power unit; a portable electrical tool having a power line, which is electrically connected to the power unit; a power-store device being electrically connected to the power unit; wherein the power unit provides power to the portable electrical tool and the power-store device, the power-store device stores the power simultaneously, so that the power-store device provides the power to the portable electrical tool while in the condition of the power line being not connected to the power unit, such as outdoor works.

### BACKGROUND OF THE INVENTION

1. Field of the Invention

The present invention generally relates to a power system applied to portable electrical tools, more particularly to a power system, which provides power to the portable electrical tools and a power-store device simultaneously, so that the power-store device can then stores power in order to provide power to the portable electrical tools without an external power source.

2. Description of the Prior Art

A battery of the accumulator in prior arts supplies a limited range of voltage values, and therefore the application, such as small electric hand torch, small electric appliance, is limited as well; otherwise, an electric saw for hewing a trunk can not be applied by such prior art.

The modern application for supplying power to electrical tools is by generators, no matter outdoor or indoor. Or, electrical tools are electrically connected to indoor outlets by means of power lines. The two ways may have the disadvantages as follows:
1. A generator is hardly moved due to its heavy weight. If a working place is a country side, a vehicle is a must. On the other hand, the generator is operated by an engine, which is noisy so as to always bother people around.
2. Power lines are suitable to outdoor works but causes inconveniences and dangers to pedestrians. The cost to the power lines is another important factor; further that, the lengths of the power lines shall limit the working areas of the electrical tools.

Therefore, how to figure out the disadvantages of prior arts is an important issue to the skilled people in the art.

### SUMMARY OF THE INVENTION

The disadvantages of the prior arts to be solved are listed as below:
1. By using a generator to supply power to electrical tools, the heavy weight of the generator is a trouble for transportation; lousy noise from the generator is not expected as well.
2. Too many power lines may hurt people around and inconvenient pedestrians, and causes higher cost.

The primary objective of the present invention is to provide a power system, which is applied to portable electrical tools. The power system comprises: a power unit; a portable electrical tool having a power line, which is electrically connected to the power unit; a power-store device being electrically connected to the power unit; wherein the power unit provides power to the portable electrical tool and the power-store device, a battery of the power-store device is electrically connected to the power unit in serial connection in order to make that a voltage value of the battery is the same as a voltage value of the power unit, so that the power-store device provides the voltage same as the voltage of the power unit to the portable electrical tool without additional transformer, which is to step up or down the voltage for meeting usages of charging the power-store device or supplying the power from the power-store device to the portable electrical tool, the power-store device stores the power simultaneously, so that the power-store device provides the power to the portable electrical tool while the portable electrical tool is operated outdoors.

As compared with the prior arts, the present invention has the advantages listed below:
1. Power lines are no more needed to prevent happening dangers, and the cost is saved.
2. The present invention can be operated outdoors without using a generator and happening lousy noise.
3. The power-store device of the present invention has more capacity than other prior arts, and can provide power and be mounted on the electrical tools so as to facilitate outdoor operations.

Other and further features, advantages, and benefits of the invention will become apparent in the following description taken in conjunction with the following drawings. It is to be understood that the foregoing general description and following detailed description are exemplary and explanatory but are not to be restrictive of the invention. The accompanying drawings are incorporated in and constitute a part of this application and, together with the description, serve to explain the principles of the invention in general terms. Like numerals refer to like parts throughout the disclosure.

### BRIEF DESCRIPTION OF THE DRAWINGS

The objects, spirits, and advantages of the preferred embodiments of the present invention will be readily understood by the accompanying drawings and detailed descriptions, wherein:

FIG. 1 illustrates a schematic block diagram of a power system of the present invention;

FIG. 2 illustrates a schematic view of a power-store device providing power to a portable electrical tool of the power system of the present invention; and

FIG. 3 illustrates a schematic view of the power-store device of the present invention.

### DETAILED DESCRIPTION OF THE INVENTION

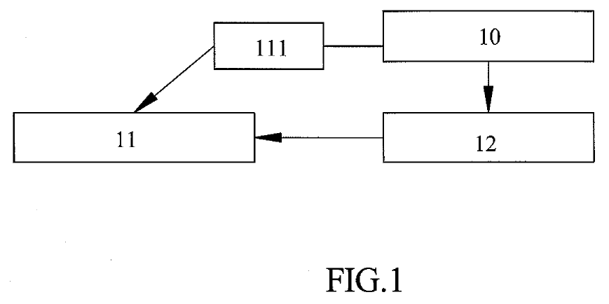

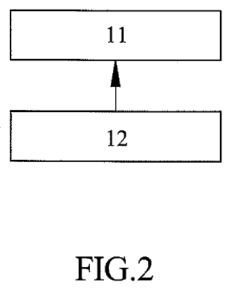

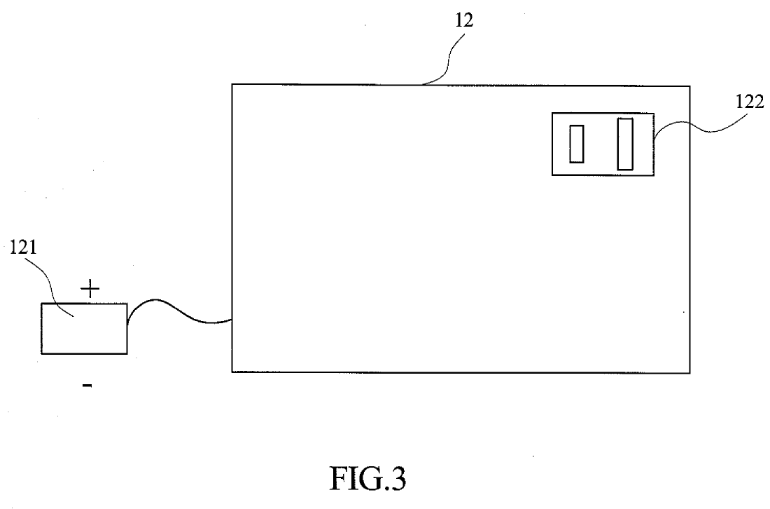

With reference to FIG. 1 to FIG. 3, a power system applied to portable electrical tools of the present invention includes: a power unit 10, which can be an indoor outlet; a portable electrical tool 11, which has a universal motor, a power line 111, etc., the power line 111 being electrically connected to the power unit 10 in order to make that the power unit 10 supplies power to the portable electrical tool 11; a power-store device 12 being disposed on the portable electrical tool 11 or separated from the portable electrical tool 11, the power-store device 12 having two poles 121, a positive pole and a negative pole, the two poles 121 being connected to the two poles of the power unit 10 in order to supply power to the power-source device 12 for storing, so that the power-store device 12 directly provides power to the portable electrical tool 11 while the power line 111 is not connected to the power unit 10, as shown in FIG. 3.

As shown in FIG. 3, the power-store device 12 has plural outlets 122 for different types of portable electrical tools.

Plural batteries of the power-store device 12 are electrically connected to the power unit 10 in serial connection in order to make that an AC voltage value of the batteries is the same as a DC voltage value of the power unit 10, so that the power-store device 12 provides the voltage same as the voltage of the power unit 10 to the universal motor of the portable electrical tool 11 without additional transformer, which is to step up or down the voltage for meeting usages of charging the power-store device 12 or supplying power from the power-store device 12 to the portable electrical tool 11.

As aforesaid, the power line 111 of the portable electrical tool 11 is electrically inserted into the power unit 10 so as to let the power unit 10 provide power to the portable electrical tool 11 and the power-store device 12 simultaneously. Therefore, the portable electrical tool 11 can be operated indoors, and the power-store device 12 can then store the power. While engaging an outdoor work, the power line 111 is not electrically connected to the power unit 10, then the power-store device 12 is the role that supplying the power to the portable electrical tool 11 for the outdoor work.

Besides, the power-store device 12 has plural outlets 122 for different types of portable electrical tools, as shown in FIG. 3. So that such different tools can be operated simultaneously.

As compared with the prior arts, the present invention has the advantages listed below:
1. The power lines for the portable electrical tool are no more needed while in an outdoor work in order to prevent happening dangers to pedestrians, and the cost to the power lines is saved.
2. The plural batteries of the power-store device of the present invention are connected in serial connection and therefore have more capacity than other prior arts, therefore the power-store device is durable. And the electrical tools may be moved to further places so as to facilitate outdoor operations.
3. Due to the durability of the power-store device, the present invention can be operated outdoors without using a generator and happening lousy noise.
4. According to the more capacity to the power-store device, this facilitates the portable electrical tool to be brought for outdoor works. So that the tool is both convenient for transportation, durable, and economic.

Although this invention has been disclosed and illustrated with reference to particular embodiments, the principles involved are susceptible for use in numerous other embodiments that will be apparent to persons skilled in the art. This invention is, therefore, to be limited only as indicated by the scope of the appended claims.

What is claimed is:

1. A power system comprising:
a power unit;
a portable electrical tool having a power line, which is electrically connected to the power unit;
a power-store device being disposed on the portable electrical tool and electrically connected to the power unit;
wherein the power unit provides power to the portable electrical tool and the power-store device, the power-store device stores the power simultaneously, so that the power-store device provides the power to the portable electrical tool while the power line is not connected to the power unit.

2. The power system as cited in claim 1, wherein a battery of the power-store device is electrically connected to the power unit in serial connection in order to make that a voltage value of the battery is the same as a voltage value of the power unit, so that the power-store device provides the voltage same as the voltage of the power unit to the portable electrical tool without additional transformer, which is to step up or down the voltage for meeting usages of charging the power-store device or supplying the power from the power-store device to the portable electrical tool.

3. The power system as cited in claim 1, wherein the power-store device has at least one outlet for different types of portable electrical tools.

4. A power system comprising:
a power unit;
a portable electrical tool having a power line, which is electrically connected to the power unit;
a power-store device being separated from the portable electrical tool and electrically connected to the power unit;
wherein the power unit provides power to the portable electrical tool and the power-store device, the power-store device stores the power simultaneously, so that the power-store device is disposed on the portable electrical tool and provides the power to the portable electrical tool while the power line is not connected to the power unit.

5. The power system as cited in claim 5, wherein a battery of the power-store device is electrically connected to the power unit in serial connection in order to make that a voltage value of the battery is the same as a voltage value of the power unit, so that the power-store device provides the voltage same as the voltage of the power unit to the portable electrical tool without additional transformer, which is to step up or down the voltage for meeting usages of charging the power-store device or supplying the power from the power-store device to the portable electrical tool.

6. The power system as cited in claim 5, wherein the power-store device has at least one outlet for different types of portable electrical tools.
